(19) United States
(12) Patent Application Publication
(10) Pub. No.: US 2011/0254490 A1
(43) Pub. Date: Oct. 20, 2011

(54) MOTOR-DRIVING APPARATUS

(76) Inventors: Alex Horng, Kaohsiung (TW); Kuan-Yin Hou, Kaohsiung (TW); Chung-Ken Cheng, Kaohsiung (TW); Cheng-Iai Cheng, Kaohsiung (TW); Yu-Fang Li, Kaohsiung (TW)

(21) Appl. No.: 12/763,500

(22) Filed: Apr. 20, 2010

(51) Int. Cl. H02P 6/14

(52) U.S. Cl. 318/400.26

(57) ABSTRACT

A motor-driving apparatus, comprising a main driving unit having a plurality of main current-driving ends coupled to a stator coil of a motor, a detection control unit coupled to the main driving unit, and an auxiliary driving unit coupled to the detection control unit and having a plurality of auxiliary current-driving ends. Wherein, the number of the main current-driving ends is the same as that of the auxiliary current-driving ends, and each of the main current-driving ends is connected to a respective one of the auxiliary current-driving ends in parallel.

### BACKGROUND OF THE INVENTION

1. Field of the Invention

The present invention generally relates to a motor-driving apparatus and, more particularly, to a motor-driving apparatus that comprises a main driving unit and an auxiliary driving unit for controlling rotation of a single motor.

2. Description of the Related Art

Electronic motors have played a big role in various industrial applications. Particularly, due to the ability to drive fans for air exchange, motors are widely used in electronic devices for cooling purpose.

Referring to FIG. 1, a conventional motor-driving apparatus is disclosed. The motor-driving apparatus comprises a control unit 81 and a driving unit 82 and is used to drive a motor 83. The control unit 81 is coupled to the driving unit 82 that, in turn, is coupled to a stator coil of the motor 83. During operation of the motor-driving apparatus, the control unit 81 outputs and sends a control signal to the driving unit 82. Upon receipt of the control signal, the driving unit 82 controls the stator coil of the motor 83 to generate alternating magnetic fields which interact with a permanent magnet of a rotor 831 of the motor 83. As a result, rotation of the rotor 831 is triggered.

Referring to FIG. 1 again, when the motor 83 is applied to a fan in an electronic device (not shown), the rotor 831 of the motor 83 may be coupled to an impeller 9 of the fan so that the rotor 831 is able to drive the impeller 9 for cooling the electronic device when driven by the motor-driving apparatus.

Since the control unit 81 and the driving unit 82 are connected in series, the motor 83 will stop operating if the control unit 81 or driving unit 82 is broken. Thus, it is desired to improve reliability of the conventional motor-driving apparatus.

### SUMMARY OF THE INVENTION

It is therefore the primary objective of this invention to provide a reliable motor-driving apparatus.

The invention discloses a motor-driving apparatus, comprising a main driving unit having a plurality of main current-driving ends coupled to a stator coil of a motor, a detection control unit coupled to the main driving unit, and an auxiliary driving unit coupled to the detection control unit and having a plurality of auxiliary current-driving ends. Wherein, the number of the main current-driving ends is the same as that of the auxiliary current-driving ends, and each of the main current-driving ends is connected to a respective one of the auxiliary current-driving ends in parallel.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a diagram of a conventional motor-driving apparatus.

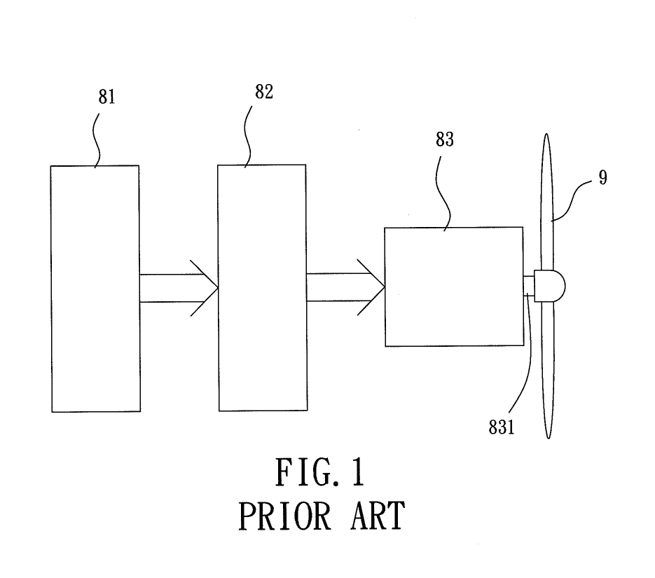

FIG. 2 shows a diagram of a motor-driving apparatus according to a first embodiment of the invention.

FIG. 3 shows a circuit diagram of the motor-driving apparatus according to the first embodiment of the invention.

FIG. 4 shows a circuit diagram of a motor-driving apparatus according to a second embodiment of the invention.

FIG. 5 shows a circuit diagram of a motor-driving apparatus according to a third embodiment of the invention.

FIG. 6 shows a circuit diagram of a motor-driving apparatus according to a fourth embodiment of the invention.

FIG. 7 shows a diagram of a motor-driving apparatus according to a fifth embodiment of the invention.

FIG. 8 shows a diagram of a motor-driving apparatus according to a sixth embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

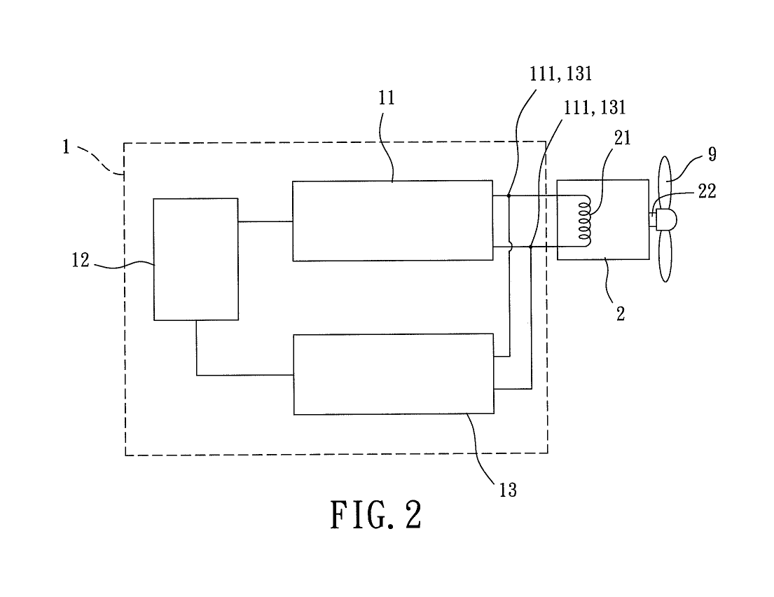

Referring to FIG. 2, a diagram of a motor-driving apparatus 1 is disclosed according to a first embodiment of the invention. The motor-driving apparatus 1 is connected to a motor 2 and comprises a main driving unit 11, a detection control unit 12 and an auxiliary driving unit 13. The main driving unit 11 comprises a plurality of main current-driving ends 111 electrically connected to a stator coil 21 of the motor 2. The main driving unit 11 is electrically connected to the detection control unit 12 which, in turn, is electrically connected to the auxiliary driving unit 13. The auxiliary driving unit 13 comprises a plurality of auxiliary current-driving ends 131, with the number of the auxiliary current-driving ends 131 being the same as that of the main current-driving ends 111. Each auxiliary current-driving end 131 is connected to a respective main current-driving end 111 in parallel. More specifically, as shown in FIG. 2, an auxiliary current-driving end 131 is electrically connected to a main current-driving end 111, and another auxiliary current-driving end 131 is electrically connected to another main current-driving end 111.

During operation of the main driving unit 11, the main driving unit 11 sends a rotation signal to the detection control unit 12. Based on the rotation signal, the detection control unit 12 determines whether the main driving unit 11 operates normally or abnormally. The rotation signal has a predetermined signal pattern such as a cyclic pulse when the main driving unit 11 operates normally. If the rotation signal is detected to be in the predetermined signal pattern by the detection control unit 12, the detection control unit 12 determines that the main driving unit 11 operates in a normal condition. If the rotation signal is detected to be in a high-level or low-level signal pattern rather than the predetermined signal pattern, the detection control unit 12 determines that the main driving unit 11 operates in an abnormal condition.

When the main driving unit 11 operates normally, the main driving unit 11 can control the direction of a current passing through the stator coil 21. In this situation, the rotation signal is determined to be in the predetermined signal pattern by the detection control unit 12. Therefore, the detection control unit 12 determines that the main driving unit 11 operates normally and generates an OFF signal to control the auxiliary driving unit 13 not to operate. The predetermined signal pattern of the rotation signal representing normal operation of the main driving unit 11 may be a cyclic pulse as stated before, but is not limited thereto. When the main driving unit 11 operates abnormally, the rotation signal is determined to be in an abnormal signal pattern instead of the predetermined signal pattern, such as a high-level or low-level signal pattern. Therefore, the detection control unit 12 determines that the main driving unit 11 operates abnormally and controls the auxiliary driving unit 13 to start operating. In this way, operation of the stator coil 21 is maintained, thus maintaining operation of the motor 2.

The motor 2 further comprises a rotor 22 coupled to the impeller 9 of the fan in the electronic device. The rotor 22 may drive the impeller 9 for cooling the electronic device when driven by the motor-driving apparatus 1.

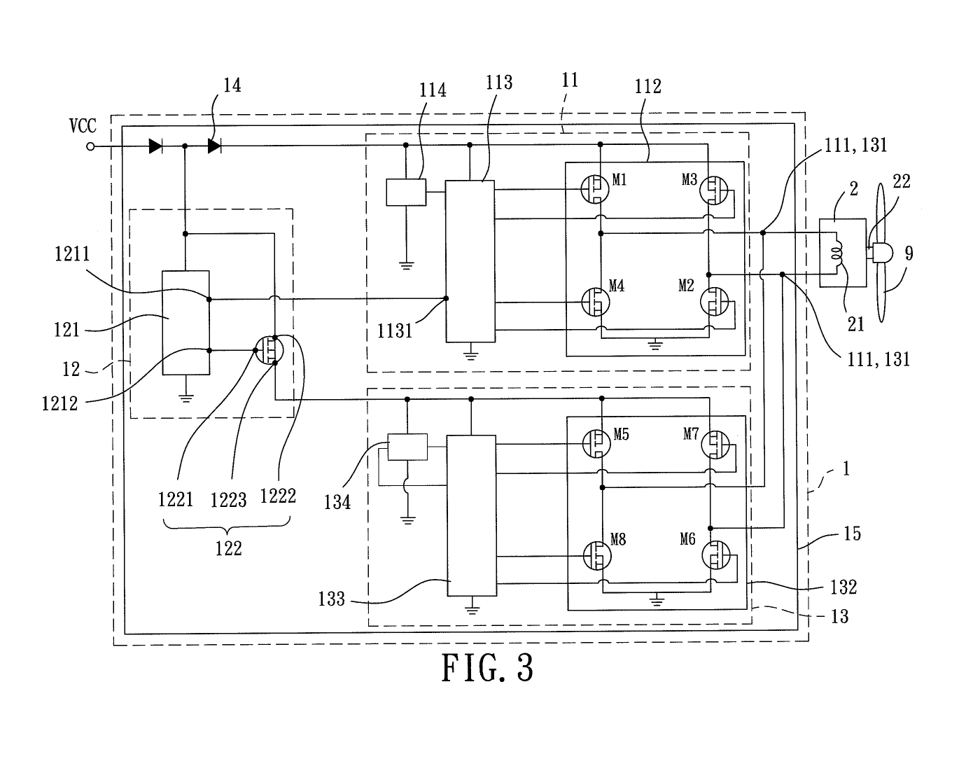

Referring to FIG. 3, a circuit diagram of the motor-driving apparatus 1 in connection to the motor 2 being a single-phased brushless direct current (BLDC) motor is disclosed according to the first embodiment of the invention. The main driving unit 11 comprises a main driving circuit 112, a main driving controller 113 and a main Hall sensor 114. The main driving circuit 112, main driving controller 113 and main Hall sensor 114 are electrically connected to a supply voltage VCC. The main driving circuit 112 forms a bridge-structured circuit consisting of a plurality of main electronic switches M1 to M4. The main electronic switches M1 and M4 are connected in series; with a main driving end where the main electronic switches M1 and M4 are connected serving as a main current-driving end 111. Similarly, the main electronic switches M2 and M3 are connected in series; with a main driving end where the main electronic switches M2 and M3 are connected serving as another main current-driving end 111. The main driving circuit 112 and the main driving controller 113 may be integrated into a driving integral chip (IC). The main Hall sensor 114 may be selectively integrated into the driving IC.

The main driving controller 113 comprises a plurality of main control ends, each being connected to a respective one of the main electronic switches M1 to M4. In addition, the main driving controller 113 is connected to the main Hall sensor 114. Based on this, the main driving controller 113 may receive a Hall sensing signal from the main Hall sensor 114 and generate a control signal for controlling the ON/OFF operations of the main electronic switches M1 to M4. The main driving controller 113 comprises a rotation signal end 1131 electrically connected to the detection control unit 12 such that the main driving controller 113 may output the rotation signal to the detection control unit 12 via the rotation signal end 1131. The rotation signal end 1131 may be selected from a Frequency Generator (FG) or Rotation Detection (RD) pin in the driving IC. Based on this, the detection control unit 12 may receive the rotation signal generated at the pin and determines the operation condition of the main driving unit 11.

Referring to FIG. 3 again, the detection control unit 12 comprises a controller 121 and a control switch 122. The controller 121 comprises a detection end 1211 electrically connected to the rotation signal end 1131 of the main driving controller 113, as well as a control end 1212 electrically connected to the control switch 122. Based on this, the controller 121 may control the ON/OFF operation of the control switch 122 according to the received rotation signal. The controller 121 may be a micro controller unit (MCU) or a conversion loop which consists of analog circuits such as operational amplifiers or transistor switches.

More specifically, referring to FIG. 3 again, the control switch 122 comprises a first end 1221, a second end 1222 and a third end 1223. The first end 1221 is electrically connected to the control end 1212 of the controller 121. The second end 1222 is coupled to the supply voltage VCC and the third end 1223 is electrically connected to an input voltage end of the auxiliary driving unit 13. Accordingly, the operation of the auxiliary driving unit 13 may be controlled based on the ON/OFF operation of the control switch 122. The control switch 122 may be a PMOS transistor switch shown in FIG. 3 or a relay.

Referring to FIG. 3 again, the auxiliary driving unit 13 comprises an auxiliary driving circuit 132, an auxiliary driving controller 133 and an auxiliary Hall sensor 134. The auxiliary driving circuit 132, auxiliary driving controller 133 and auxiliary Hall sensor 134 are coupled to the supply voltage VCC via the control switch 122. The auxiliary driving circuit 132 forms a bridge-structured circuit consisting of a plurality of auxiliary electronic switches M5 to M8. The auxiliary electronic switches M5 and M8 are connected in series, with an auxiliary driving end where the auxiliary electronic switches M5 and M8 are connected serving as an auxiliary current-driving end 131. Similarly, the auxiliary electronic switches M6 and M7 are connected in series, with an auxiliary driving end where the auxiliary electronic switches M6 and M7 are connected serving as another auxiliary current-driving end 131. The auxiliary driving controller 133 comprises a plurality of auxiliary control ends, each being connected to a respective one of the auxiliary electronic switches M5 to M8. In addition, the auxiliary driving controller 133 is connected to the auxiliary Hall sensor 134. The auxiliary driving circuit 132 and the auxiliary driving controller 133 may be integrated into a driving IC. The auxiliary Hall sensor 134 may also be selectively integrated into the driving IC.

When the motor 2 rotates abnormally due to the malfunction of the main Hall sensor 114, the auxiliary Hall sensor 134 may start to operate in order to keep monitoring the magnetic pole location of the rotor 2, thereby maintaining the operation of the motor 2.

Without consideration of the potential malfunction of the main Hall sensor 114, the auxiliary Hall sensor 134 of the auxiliary driving unit 13 may be omitted and the auxiliary driving controller 133 is connected to the main Hall sensor 114 instead, thus reducing the costs.

In the first embodiment above, the detection control unit 12 determines whether to activate the auxiliary driving unit 13 based on the operation condition of the main driving unit 11. The detailed operations of the detection control unit 12 and auxiliary driving unit 13 are described below.

During operation of the main driving unit 11, the main driving unit 11 generates the rotation signal. The controller 121 determines the operation condition of the main driving unit 11 by detecting the predetermined signal pattern of the rotation signal. If the rotation signal is detected to be in the predetermined signal pattern is detected, the controller 121 determines that the main driving unit 11 operates in a normal condition and controls the control switch 122 to turn off, stopping the supply voltage VCC to be supplied to the auxiliary driving circuit 132, auxiliary driving controller 133 and auxiliary Hall sensor 134. As a result, the auxiliary driving unit 13 is not operated.

When the main driving unit 11 operates abnormally, the rotation signal generated by the main driving unit 11 is determined to be abnormal by the controller 121. In response, the controller 121 controls the control switch 122 to turn on, allowing the supply voltage VCC to be supplied to the auxiliary driving circuit 132, auxiliary driving controller 133 and auxiliary Hall sensor 134. Therefore, power required for the auxiliary driving unit 13 to maintain operation of the motor 2 is provided. In the above embodiment, if the controller 121 determines that the rotational speed of the motor 2 does not match a predetermined rotational speed based on the rotation signal received from the FG pin, the controller 121 may determine that the main driving unit 11 is in an abnormal operation.

Referring to FIG. 3 again, the main driving unit 11 further comprises a protection diode 14 connected between the main driving unit 11 and the auxiliary driving unit 13 in series. Namely, the protection diode 14 is connected between two input voltage ends of the main driving unit 11 and the auxiliary driving unit 13. Based on this, when the main driving unit 11 is burned out due to an abnormal current passing therethrough, the detection control unit 12 and the auxiliary driving unit 13 may be protected from the abnormal current via the protection diode 14.

Referring to FIG. 3 again, the motor-driving apparatus 1 further comprises a circuit board unit 15. The circuit board unit 15 is a single circuit board on which the peripheral components of the motor-driving apparatus 1, main driving unit 11, detection control unit 12, auxiliary driving unit 13 and protection diode 14 are mounted. The layout for the components is subsequently implemented on the circuit board.

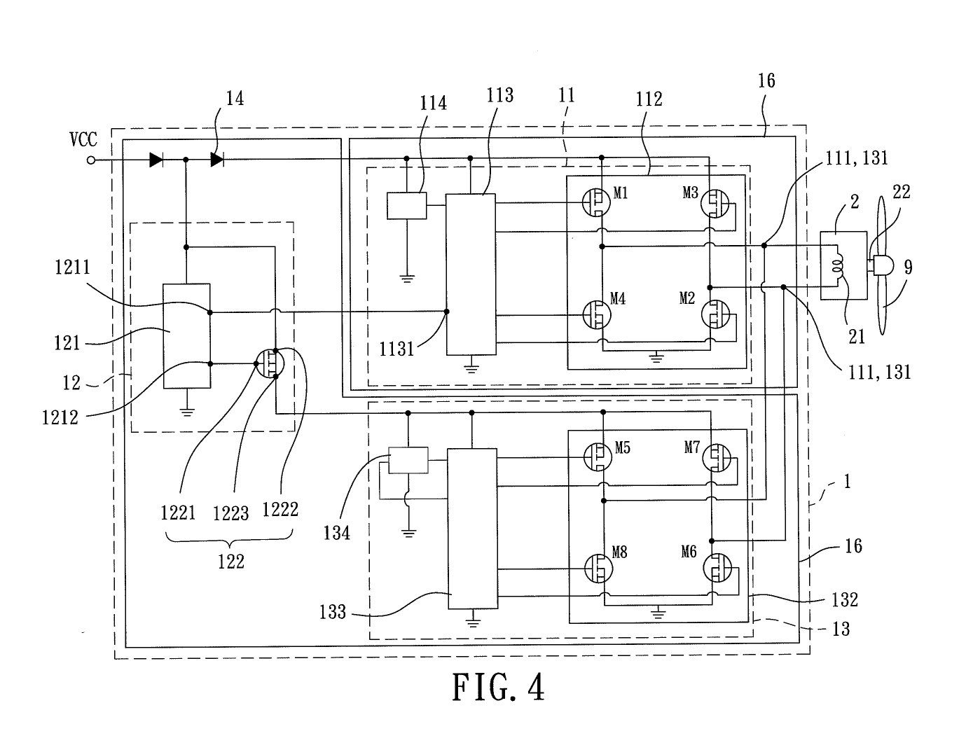

Referring to FIG. 4, a motor-driving apparatus 1 is disclosed according to a second embodiment of the invention. In comparison with the first embodiment, the motor-driving apparatus 1 in this embodiment comprises a circuit board unit 16 comprising two circuit boards. One circuit board is mounted with the main driving unit 11 and another circuit board is mounted with the auxiliary driving unit 13. The protection diode 14 may be mounted on either circuit board. The detection control unit 12 and the auxiliary driving unit 13 are preferably mounted on the same circuit board. Based on the arrangement, when the main driving unit 11 is broken, only the circuit board mounted with the main driving unit 11 requires to be replaced. The arrangement greatly facilitates replacing circuit board when repairing the motor-driving apparatus 1.

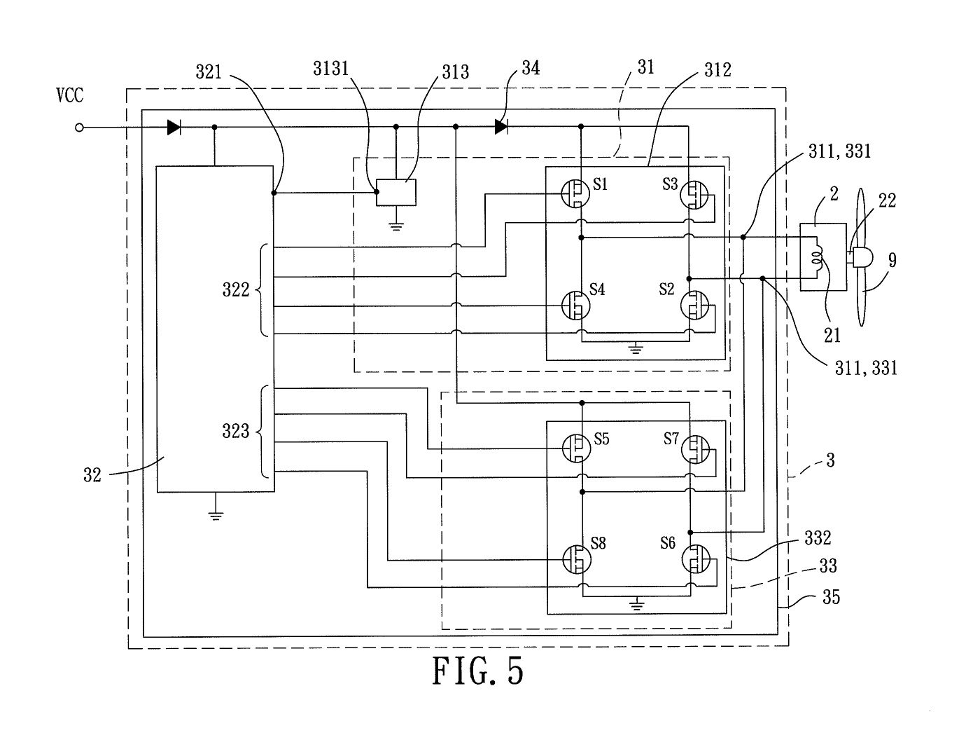

Referring to FIG. 5, a motor-driving apparatus 3 is disclosed according to a third embodiment of the invention. The motor-driving apparatus 3 comprises a main driving unit 31, a detection control unit 32 and an auxiliary driving unit 33. The main driving unit 31 comprises a plurality of main current-driving ends 311 electrically connected to the stator coil 21 of the motor 2. The main driving unit 31 is electrically connected to the detection control unit 32 which, in turn, is electrically connected to the auxiliary driving unit 33. The auxiliary driving unit 33 also comprises a plurality of auxiliary current-driving ends 331, with the number of the auxiliary current-driving ends 331 being the same as that of the main current-driving ends 311. Each auxiliary current-driving end 331 is connected to a respective main current-driving end 311 in parallel.

Referring to FIG. 5 again, a circuit diagram of the motor-driving apparatus 3 in connection to the motor 2 being a single-phased BLDC motor is disclosed according to the third embodiment of the invention. In comparison with the first and second embodiments, the main driving unit 31 in the embodiment omits the main driving controller 113. Instead, the main driving unit 31 merely comprises a main driving circuit 312 and a main Hall sensor 313. The main driving circuit 312 and main Hall sensor 313 are electrically connected to the supply voltage VCC. The main driving circuit 312 forms a bridge-structured circuit consisting of a plurality of main electronic switches S1 to S4. The main electronic switches S1 and S4 are connected in series, with a main driving end where the main electronic switches S1 and S4 are connected serving as a main current-driving end 311. Similarly, the main electronic switches S2 and S3 are connected in series, with a main driving end where the main electronic switches S2 and S3 are connected serving as another main current-driving end 311.

Referring to FIG. 5, the main Hall sensor 313 at least comprises a rotation signal end 3131 electrically connected to the detection control unit 32. Based on this, the detection control unit 32 may receive a Hall sensing signal from the main Hall sensor 313. In the third embodiment, the Hall sensing signal serves as the rotation signal. The detection control unit 32 may receive the rotation signal and determines the operation condition of the main driving unit 31 based on the received rotation signal.

Referring to FIG. 5 again, the detection control unit 32 is an MCU having various functions such as signal receiving and outputting, determination, and calculation and so on. In comparison with the first and second embodiments, the detection control unit 32 in the third embodiment has incorporated operations of the previous control switch 122 and driving controllers 113 and 133. Thus, costs and volume of the motor-driving apparatus 3 are reduced.

The detection control unit 32 comprises a detection end 321, a plurality of first control ends 322 and a plurality of second control ends 323. The detection end 321 is electrically connected to the rotation signal end 3131 of the main Hall sensor 313. Each first control end 322 is electrically connected to a respective one of the main electronic switches S1 to S4 so that the detection control unit 32 may control the ON/OFF operation of the main electronic switches S1 to S4. The second control ends 323 of the detection control unit 32 are electrically connected to the auxiliary driving unit 33.

The auxiliary driving unit 33 comprises an auxiliary driving circuit 332 electrically connected to the supply voltage VCC. The auxiliary driving circuit 332 forms a bridge-structured circuit consisting of a plurality of auxiliary electronic switches S5 to S8. The auxiliary electronic switches S5 and S8 are connected in series, with an auxiliary driving end where the auxiliary electronic switches S5 and S8 are connected serving as an auxiliary current-driving end 331. Similarly, the auxiliary electronic switches S6 and S7 are connected in series, with an auxiliary driving end where the auxiliary electronic switches S6 and S7 are connected serving as another auxiliary current-driving end 331. Each second output end 323 is electrically connected to a respective one of the auxiliary electronic switches S5 to S8 so that the detection control unit 32 may control the ON/OFF operation of the auxiliary electronic switches S5 to S8.

When the detection control unit 32 receives the Hall sensing signal from the main Hall sensor 313 as a rotation signal and determines that the main driving unit 31 is in a normal operation based on the rotation signal, the detection control unit 32 controls the auxiliary driving unit 33 not to operate. On the contrary, if the detection control unit 32 determines that the main driving unit 31 is in an abnormal operation based on the rotation signal, the detection control unit 32 controls the auxiliary driving unit 33 to start operating in order to maintain the operation of the motor 2.

Referring to FIG. 5 again, the motor-driving apparatus 3 further comprises a protection diode 34 connected between the main driving unit 31 and the auxiliary driving unit 33 in series. Namely, the protection diode 34 is connected between two input voltage ends of the main driving unit 31 and the auxiliary driving unit 33.

Referring to FIG. 5 again, the motor-driving apparatus 3 further comprises a circuit board unit 35. The circuit board unit 35 is a single circuit board on which the peripheral components of the main driving unit 31, detection control unit 32, auxiliary driving unit 33 and protection diode 34 are mounted. The layout for the components is subsequently implemented on the circuit board.

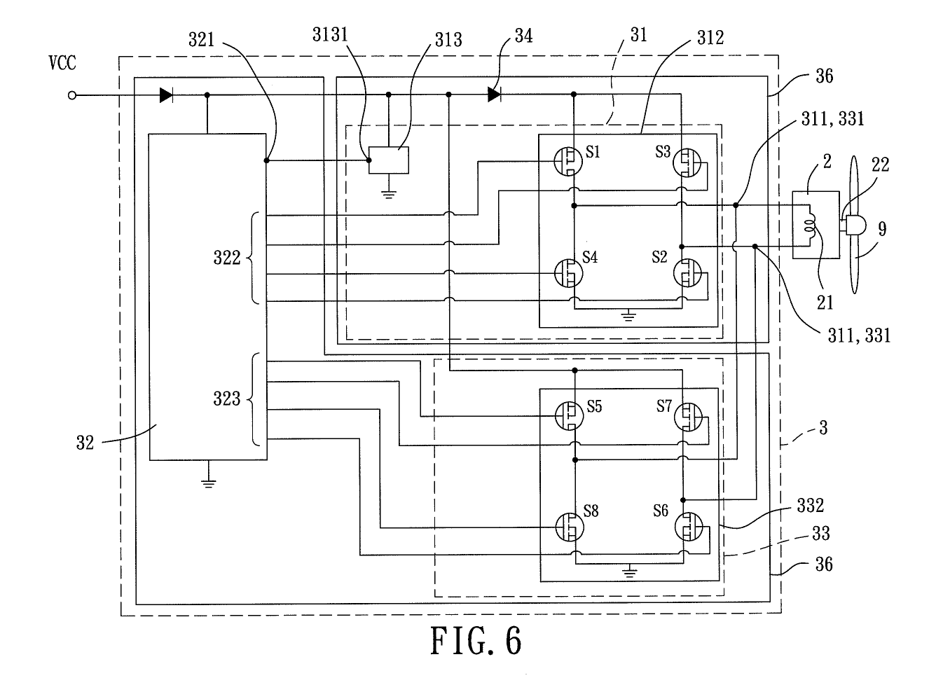

Referring to FIG. 6, a motor-driving apparatus 3 is disclosed according to a fourth embodiment of the invention. In comparison with the third embodiment, the motor-driving apparatus 3 in this embodiment comprises a circuit board unit 36 comprising two circuit boards. One circuit board is mounted with the main driving unit 31 and another circuit board is mounted with the auxiliary driving unit 33. The detection control unit 32 and the protection diode 34 may be mounted on the same circuit board. The detection control unit 32 and the auxiliary driving unit 33 are preferably mounted on the same circuit board. Based on this, when the main driving unit 31 is broken, only the circuit board mounted with the main driving unit 31 requires to be replaced. The arrangement greatly facilitates replacing circuit board when repairing the motor-driving apparatus 3.

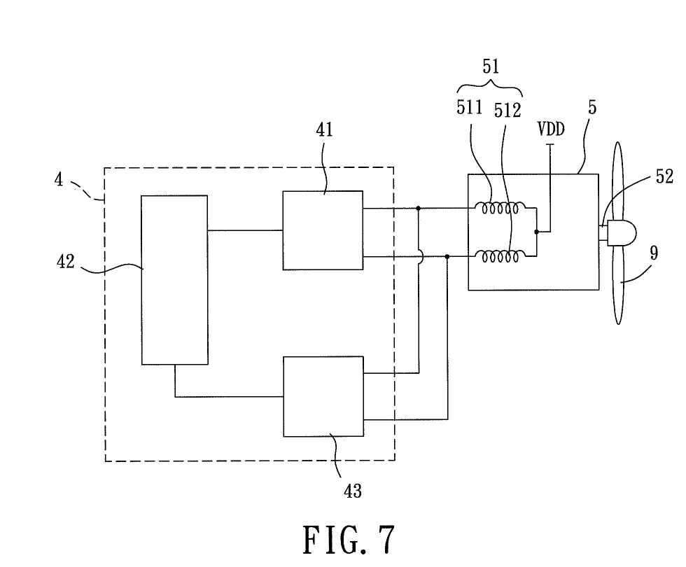

Referring to FIG. 7, a motor-driving apparatus 4 is disclosed according to a fifth embodiment of the invention. The motor-driving apparatus 4 is electrically connected to a motor 5 and comprises a main driving unit 41, a detection control unit 42 and an auxiliary driving unit 43. The motor 5 is a double-phased BLDC motor and comprises a stator coil 51. The stator coil 51 comprises a first coil 511 and a second coil 512. To comply with the double-phased BLDC motor, the main driving unit 41 and the auxiliary driving unit 43 are designed as double-phased bridge-structured circuits. Through slight modifications of the bridge-structured circuits, the main driving unit 41 may be replaced by the auxiliary driving unit 43 to maintain operation of the motor 5 when the main driving unit 41 is broken.

The detailed circuit diagrams of the main driving unit 41 and the auxiliary driving unit 43 in connection to the detection control unit 42, as well as arrangements of circuit board(s), may be implemented according to the first to fourth embodiments in comply with the double-phased bridge-structured circuits, so they are not described herein again for brevity.

Furthermore, the motor 5 comprises a rotor 52 coupled to the impeller 9 of the fan for cooling purpose.

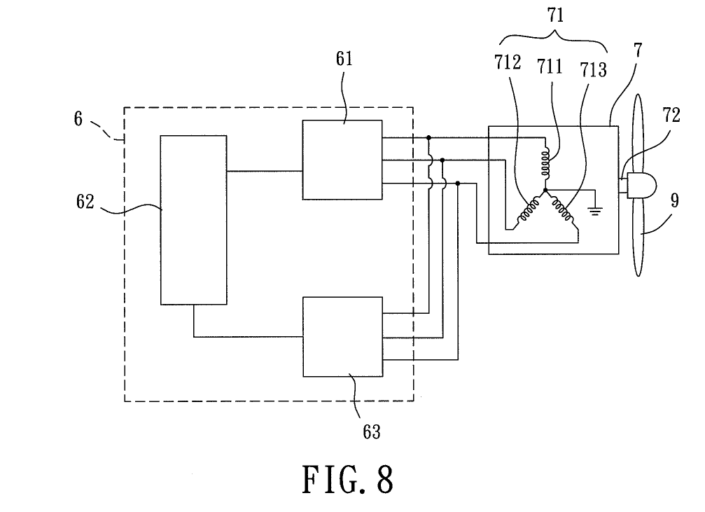

Referring to FIG. 8, a motor-driving apparatus 6 is disclosed according to a sixth embodiment of the invention. The motor-driving apparatus 6 is electrically connected to a motor 7 and comprises a main driving unit 61, a detection control unit 62 and an auxiliary driving unit 63. The motor 7 is a triple-phased BLDC motor and comprises a stator coil 71. The stator coil 71 comprises a first coil 711, a second coil 712 and a third coil 713. To comply with the triple-phased BLDC motor, the main driving unit 61 and the auxiliary driving unit 63 are designed as triple-phased bridge-structured circuits. Through slight modifications of bridge-structured circuits, the main driving unit 61 may be replaced by the auxiliary driving unit 63 to maintain operation of the motor 7 when the main driving unit 61 is broken.

The detailed circuit diagrams of the main driving unit 61 and the auxiliary driving unit 63 in connection to the detection control unit 62, as well as arrangements of circuit board(s), may be implemented according to the first to fourth embodiments in comply with the triple-phased bridge-structured circuits, so they are not described herein again for brevity.

Furthermore, the motor 7 comprises a rotor 72 coupled to the impeller 9 of the fan for cooling purpose.

In conclusion, when a main driving unit of a motor-driving apparatus is broken, the invention is capable of maintaining operation of the motor-driving apparatus by a detection control unit activating an auxiliary driving unit thereof. Thus, operation reliability of the motor-driving apparatus is improved.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor-driving apparatus, comprising:
a main driving unit having a plurality of main current-driving ends coupled to a stator coil of a motor;
a detection control unit coupled to the main driving unit; and
an auxiliary driving unit coupled to the detection control unit and having a plurality of auxiliary current-driving ends, wherein the number of the main current-driving ends is the same as that of the auxiliary current-driving ends, and each of the main current-driving ends is connected to a respective one of the auxiliary current-driving ends in parallel.

2. The motor-driving apparatus as claimed in claim 1, wherein the main driving unit further comprises:
a main driving circuit coupled to a supply voltage, wherein the main driving circuit comprises a bridge-structured circuit having a plurality of main electronic switches and a plurality of main driving ends serving as the main current-driving ends;
a main driving controller coupled to the supply voltage and having a plurality of main control ends, each being connected to a respective one of the main electronic switches; and
a main Hall sensor coupled to the supply voltage and the main driving controller.

3. The motor-driving apparatus as claimed in claim 2, wherein the main driving controller and the main driving circuit are integrated into a driving integral chip (IC).

4. The motor-driving apparatus as claimed in claim 3, wherein the main Hall sensor is integrated into the driving IC.

5. The motor-driving apparatus as claimed in claim 2, wherein the main driving controller further comprises a rotation signal end coupled to the detection control unit.

6. The motor-driving apparatus as claimed in claim 2, wherein the detection control unit comprises a controller and a control switch, the controller comprises a detection end and a control end, the detection end is coupled to a rotation signal end of the main driving controller, the control switch comprises a first end, a second end and a third end, the first end is coupled to the control end of the controller, the second end is coupled to the supply voltage, and the third end is coupled to the auxiliary driving unit.

7. The motor-driving apparatus as claimed in claim 6, wherein the control switch is a PMOS transistor or relay.

8. The motor-driving apparatus as claimed in claim 2, wherein the auxiliary driving unit comprises:
an auxiliary driving circuit coupled to the supply voltage, wherein the auxiliary driving circuit comprises a bridge-structured circuit having a plurality of auxiliary electronic switches and a plurality of auxiliary driving ends serving as the auxiliary current-driving ends;
an auxiliary driving controller coupled to the supply voltage and having a plurality of auxiliary control ends, each being connected to a respective one of the auxiliary electronic switches; and
an auxiliary Hall sensor coupled to the supply voltage and the auxiliary driving controller.

9. The motor-driving apparatus as claimed in claim 1, further comprising a protection diode connected between the main driving unit and the auxiliary driving unit in series.

10. The motor-driving apparatus as claimed in claim 8, wherein the auxiliary driving controller and the auxiliary driving circuit are integrated into a driving integral chip (IC).

11. The motor-driving apparatus as claimed in claim 10, wherein the auxiliary Hall sensor is integrated into the driving IC.

12. The motor-driving apparatus as claimed in claim 9, further comprising a circuit board on which the peripheral components of the main driving unit, the detection control unit, the auxiliary driving unit and the protection diode are mounted.

13. The motor-driving apparatus as claimed in claim 9, further comprising two circuit boards, one of the circuit boards is mounted with the main driving unit and another one of the circuit boards is mounted with the auxiliary driving unit, and the detection control unit and the protection diode are mounted on one of the circuit boards.

14. The motor-driving apparatus as claimed in claim 13, wherein the detection control unit and the auxiliary driving unit are mounted on the same circuit board.

15. The motor-driving apparatus as claimed in claim 1, wherein the main driving unit further comprises:
a main driving circuit coupled to a supply voltage, wherein the main driving circuit comprises a bridge-structured circuit having a plurality of main electronic switches and a plurality of main driving ends serving as the main current-driving ends; and
a main Hall sensor coupled to the supply voltage and having a rotation signal end coupled to the detection control unit.

16. The motor-driving apparatus as claimed in claim 15, wherein the detection control unit is a micro controller unit (MCU) having a detection end, a plurality of first control ends and a plurality of second control ends, the detection end is coupled to the rotation signal end of the main Hall sensor, each of the first control ends is coupled to a respective one of the main electronic switches, and the second control ends are coupled to the auxiliary driving unit.

17. The motor-driving apparatus as claimed in claim 16, wherein the auxiliary driving unit further comprises an auxiliary driving controller coupled to the supply voltage, wherein the auxiliary driving controller comprises a bridge-structured circuit having a plurality of auxiliary electronic switches and a plurality of auxiliary driving ends serving as the auxiliary current-driving ends, and the second control ends are coupled to the auxiliary electronic switches.

18. The motor-driving apparatus as claimed in claim 15, further comprising a protection diode connected between the main driving unit and the auxiliary driving unit in series.

19. The motor-driving apparatus as claimed in claim 18, further comprising a circuit board on which the peripheral components of the main driving unit, the detection control unit, the auxiliary driving unit and the protection diode are mounted.

20. The motor-driving apparatus as claimed in claim 18, further comprising two circuit boards, one of the circuit boards is mounted with the main driving unit and another one of the circuit boards is mounted with the auxiliary driving unit, and the detection control unit and the protection diode are mounted on one of the circuit boards.

21. The motor-driving apparatus as claimed in claim 20, wherein the detection control unit and the auxiliary driving unit are mounted on the same circuit board.

22. The motor-driving apparatus as claimed in claim 1, wherein the motor has a rotor coupled to an impeller.
